(19) United States
(12) Patent Application Publication
(10) Pub. No.: US 2012/0063714 A1
(43) Pub. Date: Mar. 15, 2012

(54) ELECTRO-OPTIC DEVICE AND MACH-ZEHNDER OPTICAL MODULATOR HAVING THE SAME

(75) Inventors: Jeong Woo PARK, Daejeon (KR); Gyungock KIM, Seoul (KR)

(73) Assignee: Electronics and Telecommunications Research Institute, Daejeon (KR)

(21) Appl. No.: 13/013,012

(22) Filed: Jan. 25, 2011

(30) Foreign Application Priority Data
Sep. 9, 2010 (KR) 10-2010-0088473

(51) Int. Cl. G02F 1/295

(52) U.S. Cl. 385/8

(57) ABSTRACT

Provided are an electro-optic device with a high modulation rate and a mach-zehnder optical modulator having the same. The electro-optic device includes a slap, a rip waveguide, a first impurity region, a second impurity region, and a third impurity region. The slap is disposed on a substrate. The rip waveguide includes a mesa extending in one direction on the slap and the slap disposed under the mesa. The first impurity region is disposed in the slap of one side of the mesa. The third impurity region is disposed in the slap of the other side of the mesa to oppose the first impurity region. The second impurity region is disposed in the rip waveguide between the first impurity region and the third impurity region.

### CROSS-REFERENCE TO RELATED APPLICATIONS

This U.S. non-provisional patent application claims priority under 35 U.S.C. §119 of Korean Patent Application No. 10-2010-0088473, filed on Sep. 9, 2010, the entire contents of which are hereby incorporated by reference.

### BACKGROUND OF THE INVENTION

The present invention disclosed herein relates to electro-optic devices, and more particularly, to an electro-optic device capable of controlling the loss or refractive index of light, and a mach-zehnder optical modulator having the same.

With the development of the semiconductor industry, semiconductor integrated circuits (ICs) such as logic devices and memory devices are becoming higher in speed and integration density. According to the high speed and the high integration density of semiconductor ICs, the communication speed between semiconductor ICs is connected directly with the performance of an electronic device including the semiconductor ICs. Typically, semiconductor ICs exchange data through electrical communication. For example, semiconductor ICs are mounted on a printed circuit board (PCB) to perform electrical communication therebetween through interconnections included in the PCB.

Research is being conducted on a scheme for using optical signals to increase the communication speed between semiconductor chips in accordance with the high integration and high speed of semiconductor devices.

### SUMMARY OF THE INVENTION

The present invention provides an electro-optic device with an improved operation speed, and a mach-zehnder optical modulator having the same.

The present invention also provides an electro-optic device optimized for high efficiency, and a mach-zehnder optical modulator having the same.

The present invention also provides an electro-optic device optimized for high integration, and a mach-zehnder optical modulator having the same.

The present invention also provides an electro-optic device optimized for low power consumption, and a mach-zehnder optical modulator having the same.

Embodiments of the present invention provide an electro-optic device including impurity regions having a lateral or vertical PNP or NPN structure at a rip waveguide.

In some embodiments of the present invention, an electro-optic device includes: a slap disposed on a substrate; a rip waveguide comprising a mesa extending in one direction on the slap and the slap disposed under the mesa; a first impurity region disposed in the slap of one side of the mesa; a third impurity region disposed in the slap of the other side of the mesa to oppose the first impurity region; and a second impurity region disposed in the rip waveguide between the first impurity region and the third impurity region.

In some embodiments, the first impurity region and the third impurity region are doped with first conductivity type impurities, and the second impurity region doped with second conductivity type impurities having the opposite conductivity type to the first conductivity type impurities. The first impurity region, the second impurity region and the third impurity region may be arranged in a PNP or NPN structure.

In other embodiments, the rip waveguide further includes: a first PN junction disposed between the first impurity region and the second impurity region; and a second PN junction disposed between the second impurity region and the third impurity region. When the depletion region of two PN junctions meet together, current start to flow through second impurity region. This current flow is utilized to achieve an electrically controlled waveguide.

In further embodiments, the first PN junction induces a first depletion region from the interface between the first impurity region and the second impurity region, and the second PN junction induces a second depletion region from the interface between the second impurity region and the third impurity region.

In still further embodiments, the electro-optic device further includes: a first electrode disposed on the first impurity region; and a second electrode disposed on the third impurity region. A power supply voltage may be applied between the first electrode and the second electrode to apply a reverse bias voltage to the first PN junction and apply a forward bias voltage to the second PN junction.

In still further embodiments, the width of the first depletion region increases to the second depletion region in proportion to the power supply voltage.

In still further embodiments, the electro-optic device further includes: a first ohmic contact layer disposed between the first impurity region and the first electrode; and a second ohmic contact layer disposed between the third impurity region and the second electrode.

In still further embodiments, the first impurity region and the third impurity region are doped with first conductivity type impurities of a first concentration, and the second impurity region is doped with the first conductivity type impurities of a second concentration lower than the first concentration. The first impurity region, the second impurity region and the third impurity region may be arranged in a PP⁻P or NN⁻N structure.

In other embodiments of the present invention, an electro-optic device includes: a slap disposed on a substrate; a rip waveguide including a mesa extending in one direction on the slap and the slap disposed under the mesa; a first impurity region disposed in the slap of the rip waveguide; a third impurity region disposed on an upper mesa and spaced apart from the first impurity region; and at least one second impurity region disposed in a lower mesa between the first impurity region and the third impurity region.

In some embodiments, the first impurity region, the second impurity region and the third impurity region are arranged in a PNP or NPN structure. In other embodiments, the first impurity region, the second impurity region and the third impurity region are arranged in a PP⁻P or NN⁻N structure.

In further embodiments of the present invention, a mach-zehnder optical modulator includes: a substrate; a clad disposed on the substrate; a slap disposed on the clad; a rip waveguide including a mesa extending in one direction on the slap, input/output waveguides inputting/outputting light along the mesa and the slap disposed under the mesa, and first and second branch waveguides connected in parallel between the input/output waveguides; and an electro-optic device including a first impurity region disposed at one side of the mesa in at least one of the first and second branch waveguides, a third impurity region disposed at the other side of the mesa to oppose the first impurity region, and at least one second impurity region disposed in the rip waveguide between the first impurity region and the third impurity region.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a plan view of an electro-optic device according to an exemplary embodiment of the present invention;

FIGS. 2A and 2B are cross-sectional views taken along a line I-I′ of FIG. 1;

FIG. 3 is a graph illustrating an energy band change in first to third impurity regions of a NPN structure;

FIG. 4 is a graph illustrating the relationship between a current and a voltage in the first to third impurity regions of a NPN structure;

FIG. 5 is a graph illustrating the waveform of a signal voltage applied to the first and third impurity regions of a NPN structure;

FIG. 6 is a graph illustrating the waveform of a current depending on the signal voltage of FIG. 5;

FIG. 7 is a graph illustrating the comparison of the capacitance according to the present invention and the capacitance according to the typical art;

FIG. 8 is a plan view of an electro-optic device according to another exemplary embodiment of the present invention;

FIGS. 9A and 9B are cross-sectional views taken along a line II-II′ of FIG. 8; and

FIG. 10 is a plan view of a mach-zehnder optical modulator according to another exemplary embodiment of the present invention.

FIG. 11 is a plan view of a mach-zehnder optical modulator according to another exemplary embodiment of the present invention.

### DETAILED DESCRIPTION OF PREFERRED EMBODIMENTS

Preferred embodiments of the present invention will be described below in more detail with reference to the accompanying drawings. Advantages and features of the present invention, and implementation methods thereof will be clarified through the following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. In the drawings, exemplary embodiments of the present invention are exaggerated for clarity of illustration and are not limited to illustrated specific shapes. Throughout the specification and drawings, like reference numerals denote like elements.

While specific terms are used in the specification, they are not used to limit the scope of the present invention, but merely used to describe embodiments of the present invention. The terms of a singular form may include a plural form unless otherwise specified. Also, the meaning of “include”, “comprise”, “including” or “comprising” specifies a property, a region, a fixed number, a step, a process, an element and/or a component but does not exclude other properties, regions, fixed numbers, steps, processes, elements and/or components. Since preferred embodiments are provided below, the order of the reference numerals given in the description is not limited thereto.

### Embodiment 1

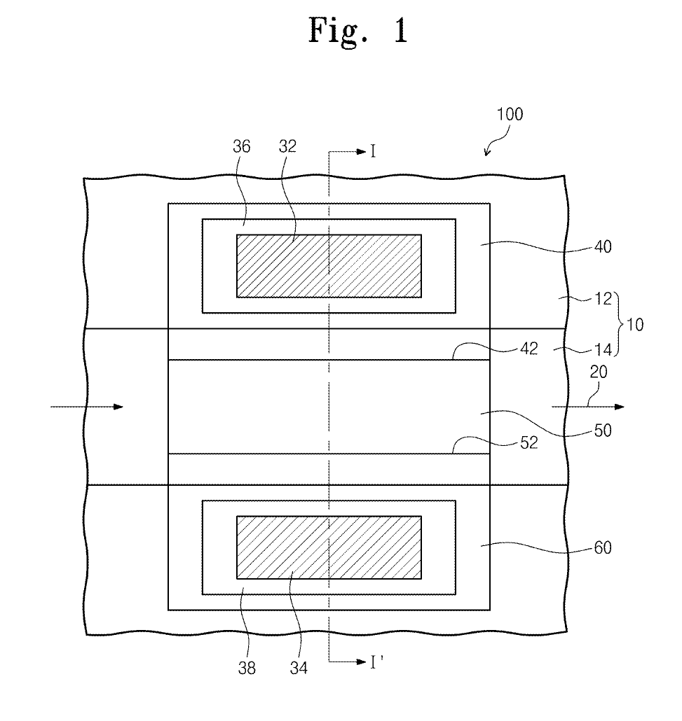

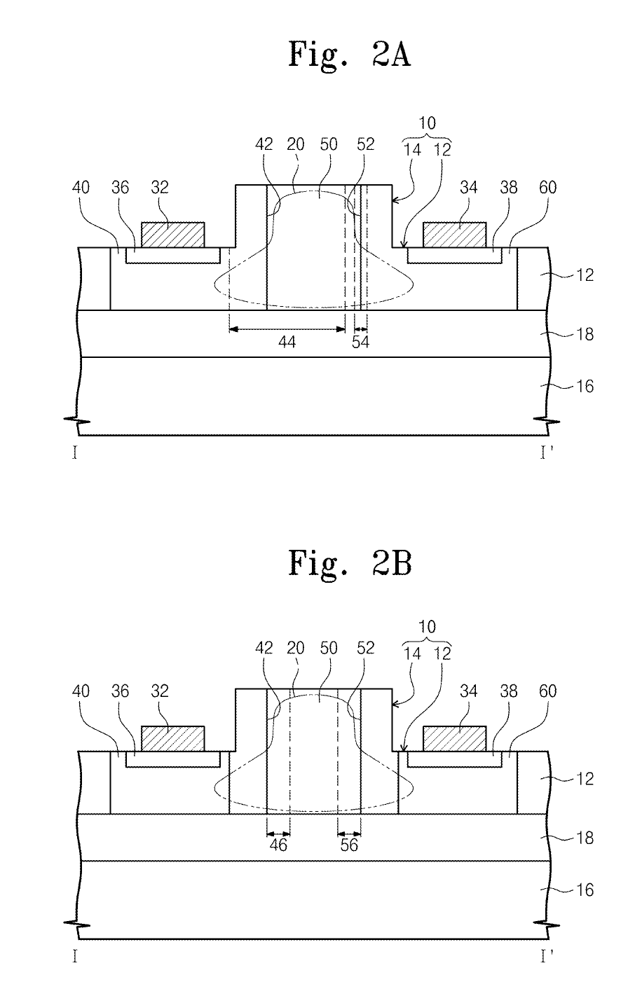

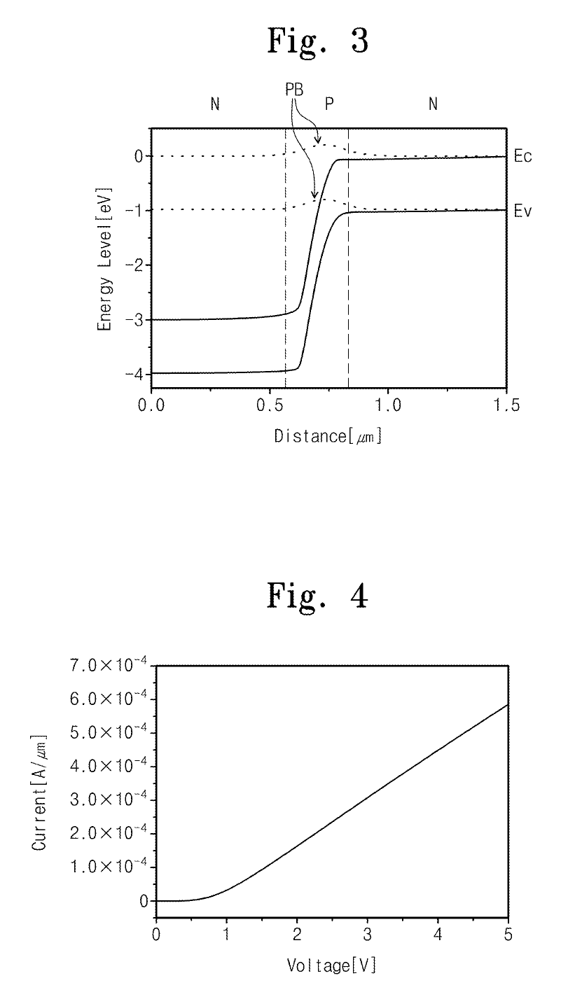

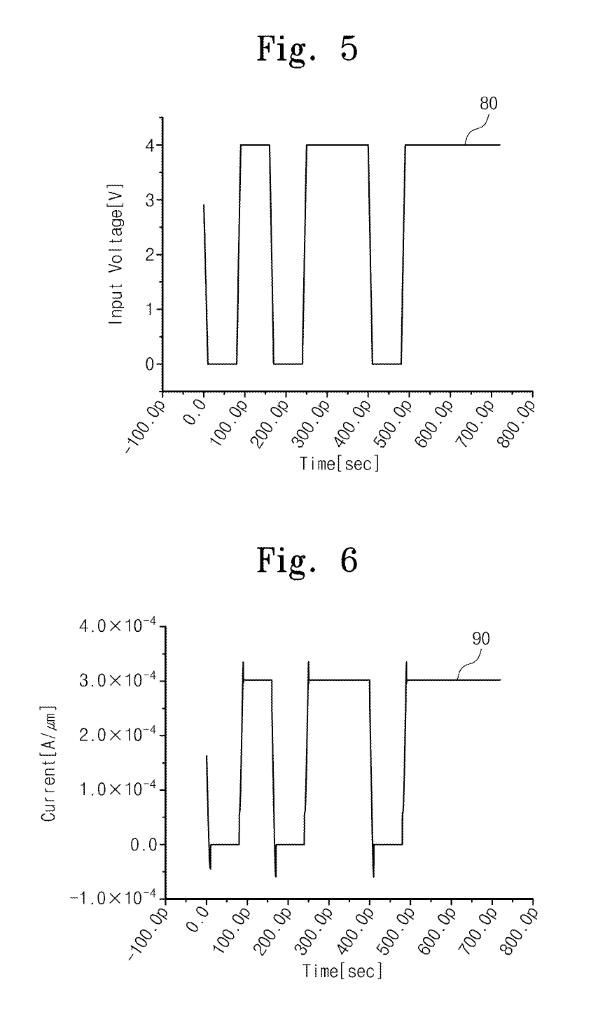

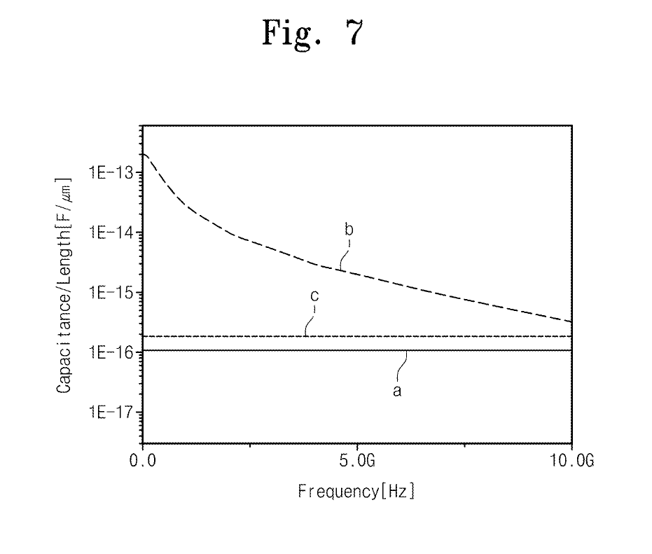

FIG. 1 is a plan view of an electro-optic device according to an exemplary embodiment of the present invention. FIGS. 2A and 2B are cross-sectional views taken along a line I-I′ of FIG. 1. FIG. 3 is a graph illustrating an energy band change in first to third impurity regions of a NPN structure. FIG. 4 is a graph illustrating the relationship between a current and a voltage in the first to third impurity regions of a NPN structure. FIG. 5 is a graph illustrating the waveform of a signal voltage applied to the first and third impurity regions of a NPN structure. FIG. 6 is a graph illustrating the waveform of a current depending on the signal voltage of FIG. 5. FIG. 7 is a graph illustrating the comparison of the capacitance according to the present invention and the capacitance according to the typical art.

Referring to FIGS. 1 and 2A, an electro-optic device 100 according to an exemplary embodiment of the present invention may include first to third impurity regions 40, 50 and 60 of a lateral NPN or PNP structure across a rip waveguide 10 on a substrate 16.

The rip waveguide 10 may include a mesa 14 extending in one direction on a slap 12, and the slap 12 disposed under the mesa 14. The slap 12 may be formed over a clad 18. The rip waveguide 10 may extend in the direction across the arrangement direction of the first to third impurity regions 40, 50 and 60. The lateral direction may be defined as the direction crossing the rip waveguide 10 on the substrate 10. The first impurity region 40 and the third impurity region 60 may be spaced apart from each other, on both sidewalls of the mesa 14. The first impurity region 40 and the third impurity region 60 may be disposed under the sidewalls of the mesa 14 and the slap 12 around the mesa 14. The rip waveguide 10 may include a first junction 42 between the first impurity region 40 and the second impurity region 50. The rip waveguide 10 may include a second junction 52 between the second impurity region 50 and the third impurity region 60. The first junction 42 and the second junction 52 may be parallel to each other. The first junction 42 and the second junction 52 may include a PN junction. The first junction 42 may induce a first depletion region 44 from the interface between the first impurity region 40 and the second impurity region 50. The second junction 52 may induce a second depletion region 54 from the interface between the second impurity region 50 and the third impurity region 60.

A lower clad 18 may be formed over the substrate 16. The substrate 16 may include monocrystalline silicon. The lower clad 18 may include a silicon oxide layer. Also, the substrate 16 and the lower clad 18 may include silicon-on-insulator (SOI). The rip waveguide 10 may include at least one of monocrystalline silicon, gallium arsenide (GaAs), and indium phosphide (InP). The first impurity region 40 and the third impurity region 60 may be doped with first conductivity type impurities, and the second impurity region 50 may be doped with second conductivity type impurities having the opposite conductivity type to the first conductivity type impurities. The first conductivity type impurities may include one of n-type donors and p-type acceptors. For example, the first impurity region 40 and the third impurity region 60 may be doped with about 3×10¹⁸ EA/cm³ donors. The second impurity region 50 may be doped with about 1×10¹⁷ EA/cm³ acceptors. A first ohmic contact region 36 and a first electrode 32 may be disposed on the first impurity region 40. The second ohmic contact region 38 and a second electrode 34 may be disposed on the third impurity region 60. The second ohmic contact region 38 may have a higher doping concentration of the first conductivity type impurities than the first and third impurity regions 40 and 60.

When a predetermined power supply voltage is applied to the first electrode 32 and the second electrode 34, a reverse bias voltage is applied to one of the first and second PN junctions 42 and 52 and a forward bias voltage is applied to the other. For example, when a negative power supply voltage and a positive power supply voltage are respectively applied to the first electrode 32 and the second electrode 34, a reverse bias voltage may be applied to the first PN junction 42 and a forward bias voltage may be applied to the second PN junction 52. The first depletion region 44 may have a larger width than the second depletion region 54.

The width of the first depletion region 44 may increase in proportion to the level of a power supply voltage. The second depletion region 54 may have a small width independent of the level of a power supply voltage. When the first depletion region 44 and the second depletion region 54 meet each other, a current may flow between the first electrode 32 and the second electrode 34.

Referring to FIGS. 1, 2A and 3, when a high voltage of about 3 V is applied between the first electrode 32 and the second electrode 34, a current may flow between the first impurity region 40 and the third impurity region 60. The valence band Ev of the third impurity region 60 may be lower than the conduction band Ec of the first impurity region 40. The second impurity region 50 may easily transmit charges such as electrons.

Because there is a potential barrier (PB) of the second impurity region 50 between the first and third impurity regions 40 and 60 at a lower voltage of about 0 V to about 1 V between the first and second electrodes 32 and 34, a current may not flow between the first electrode 32 and the second electrode 34. Herein, the current may increase the concentration of carriers of the second impurity region 50 to change the absorption index and the refractive index of light. A change in the refractive index may be expressed as Equation (1).

Δn=−[8.8×10⁻²²*ΔN+8.5×10⁻¹⁸*(ΔP)^{0.8}] (1)

In Equation (1), ΔN may include an electron variation per unit cube (cm³) and ΔP may include a hole variation per unit cube (cm³). The refractive index change may increase in proportion to the electron/hole variation. Light 20 may propagate along the rip waveguide 10. The refractive index or loss that the light 20 feels may be changed when a current flows in the first to third impurity regions 40, 50 and 60. This change of refractive index or loss can provide an electrically controlled waveguide.

Thus, the electro-optic device 100 may change the refractive index of the light 20 that propagates along the rip waveguide 10.

Referring to FIGS. 1, 2A and 4, at a voltage with a predetermined level or more, the current may increase in proportion to the voltage. When a voltage of 1 V or less is applied thereto, a current does not flow between the first and third impurity regions 40 and 60. When a voltage of 1 V or more is applied thereto, a current increasing in proportion to the voltage may flow. When the voltage applied to the first and second electrodes 32 and 34 is controlled, the current flowing between the first and third impurity regions 40 and 60 may be controlled.

Referring to FIGS. 1, 5 and 6, a current 90 of the same waveform as a signal voltage 80 applied to the first and second electrodes 32 and 34 may flow in the first to third impurity regions 40, 50 and 60 of a lateral NPN structure. For example, when a signal voltage 80 of a square wave is applied thereto, a current 90 of the same wave (i.e., the square wave) as the signal voltage 80 may flow in the first to third impurity regions 40, 50 and 60. The signal voltage 80 and the current 90 may change at the same rate of about 12.5 Gbps. Thus, the electro-optic device 100 may operate at high speed.

Referring to FIGS. 1 and 7, the NPN junction (a) of the present invention may have a lower capacitance than a forward-biased PN diode (b) and a reverse-biased PN diode (c).

The forward-biased PN diode (b) may include a PN junction to which a forward bias voltage of about 1 V is applied. The capacitance of the forward-biased PN diode (b) may change according to the frequency. The forward-biased PN diode (b) may be unsuitable as an electro-optic device because the modulation of the forward-biased PN diode (b) may vary according to a change in the frequency. The reverse-biased PN diode (c) may include a PN junction to which a reverse bias voltage of about 1 V is applied. The reverse-biased PN diode (c) may have a constant capacitance of about 2×10⁻¹⁶ F/μm independent of the frequency.

As the electro-optic device 100 according to an exemplary embodiment of the present invention, the NPN junction (a) may include the first to third impurity regions 40, 50 and 60 of an NPN structure in which a voltage of about 1 V is applied between the first and second electrodes 32 and 34. The NPN junction (a) may have a capacitance of about 1×10⁻¹⁶ F/μm. The NPN junction (a) may have a ½ times lower capacitance than the reverse-biased PN diode (c). Thus, the electro-optic device 100 according to an exemplary embodiment of the present invention may operate at a higher speed than the typical PN diodes (b and c).

Referring to FIGS. 1 and 2B, an electro-optic device 100 according to an exemplary embodiment of the present invention may include first to third impurity regions 40, 50 and 60 of a lateral NN⁻N or PP⁻P structure across a rip waveguide 10. The first and third impurity regions 40 and 60 may be doped with one of first conductivity type impurities and second conductivity type impurities at a high concentration. The second impurity region 50 may be doped with the first conductivity type impurities or the second conductivity type impurities at a low concentration.

A first junction 42 may be provided at the boundary between the first impurity region 40 and the second impurity region 50. A second junction 52 may be provided at the boundary between the second impurity region 50 and the third impurity region 60. The first junction 42 and the second junction 52 may include an NN⁻ junction or a PP⁻ junction. The NN⁻ junction and the PP⁻ junction may have a lower potential barrier than a PN junction. When a predetermined level of voltage is applied to the NN⁻ junction and the PP⁻ junction, a current may flow according to a decrease in the potential barrier.

When a voltage is applied to the first electrode 32 and the second electrode 34, a third depletion region 46 may be induced at the first junction 42 and a fourth depletion region 56 may be induced at the second junction 52. The third depletion region 46 and the fourth depletion region 56 may be induced in the second impurity region 50. The third depletion region 46 and the fourth depletion region 56 may be sections in the second impurity region 50 where the concentration of minority carriers. The third depletion region 46 and the fourth depletion region 56 may have the same width. When the third depletion region 46 and the fourth depletion region 56 meet each other, a current may flow in the first to third impurity regions 40, 50 and 60.

Thus, the electro-optic device 100 according to an exemplary embodiment of the present invention may include first to third impurity regions 40, 50 and 60 with a lateral NPN, PNP, NN⁻N or PP⁻P structure in the rip waveguide 10.

### Embodiment 2

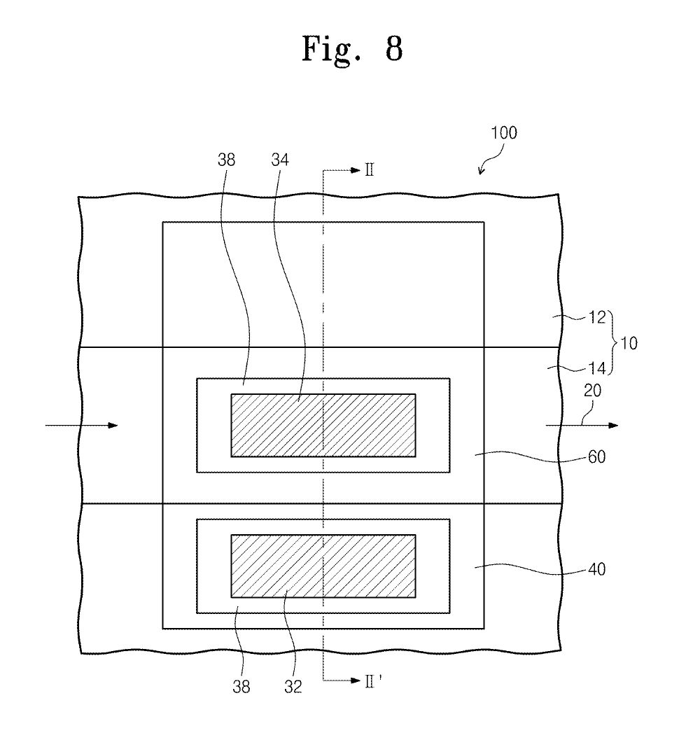

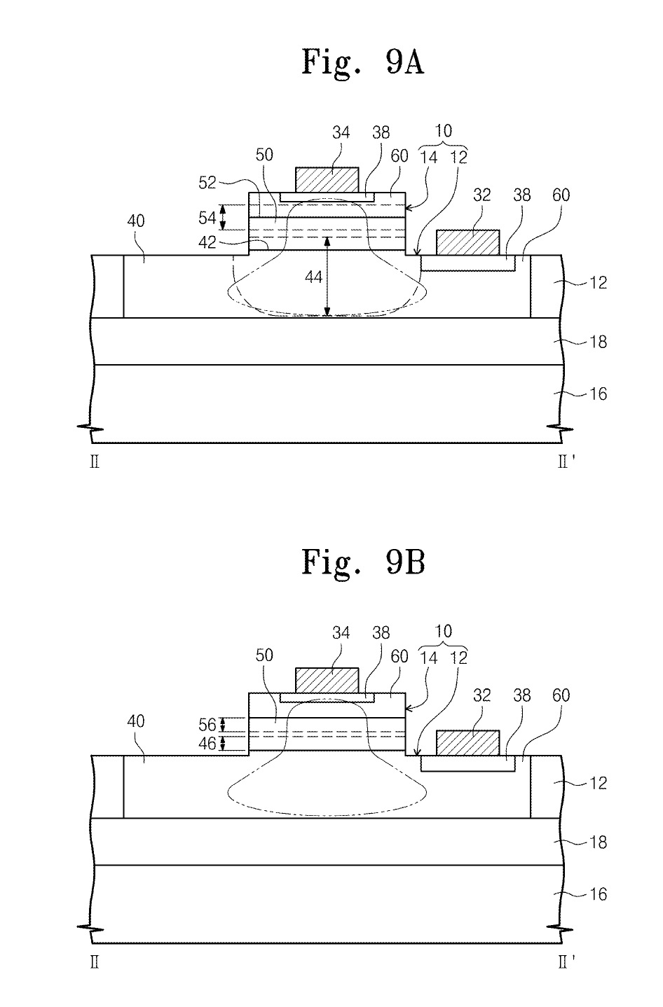

FIG. 8 is a plan view of an electro-optic device according to another exemplary embodiment of the present invention. FIGS. 9A and 9B are cross-sectional views taken along a line II-IP of FIG. 8.

Referring to FIGS. 8 and 9A, an electro-optic device 100 according to another exemplary embodiment of the present invention may include first to third impurity regions 40, 50 and 60 of a vertical NPN or PNP structure stacked in a rip waveguide 10. Herein, a description of an overlap with Embodiment 1 will be omitted for conciseness.

The rip waveguide 10 may include a mesa 14 extending in one direction, and a slap 12 disposed under the mesa 14. The first impurity region 40 may be disposed in the slap 12 under the mesa 14. The first impurity region 40 may be disposed under the mesa 14. The third impurity region 60 may be disposed on an upper mesa 14. The vertical direction may be defined as the stacking direction on a substrate 16. The first impurity region 40 and the third impurity region 60 may be disposed on the upper mesa 14 and under the mesa 14 such that they are spaced apart from each other. The second impurity region 50 may be disposed in a lower mesa 14 between the first and third impurity regions 40 and 60. The mesa 14 may include a first junction 42 and a second junction 44. The first junction 42 may correspond to the boundary between the first and second impurity regions 40 and 50. The second junction 44 may correspond to the boundary between the second and third impurity regions 50 and 60. The first junction 42 and the second junction 44 may be parallel to the substrate 16. The first junction 42 and the second junction 44 may include a PN junction. The rip waveguide 10 may include a plurality of PN junctions that are parallel to the substrate 16.

The first impurity region 40 and the third impurity region 60 may be doped with first conductivity type impurities, and the second impurity region 50 may be doped with second conductivity type impurities having the opposite conductivity type to the first conductivity type impurities. The first impurity region 40 and the third impurity region 60 may be doped with the first conductivity type impurities at different doping concentrations. A first ohmic contact region 36 and a second ohmic contact region 38 may have a higher doping concentration of the first conductivity type impurities than the first impurity region 40. The first conductivity type impurities may include one of n-type donors and p-type acceptors.

A first electrode 32 may be disposed on the slap 12, and a second electrode 34 may be disposed on the upper mesa 14. When a predetermined power supply voltage is applied to the first electrode 32 and the second electrode 34, a first depletion region 44 may be induced in the first junction 42 and a second depletion region 54 may be induced in the second junction 52. A reverse bias voltage is applied to one of the first and second PN junctions 42 and 52 and a forward bias voltage is applied to the other. For example, when a negative power supply voltage and a positive power supply voltage are respectively applied to the first electrode 32 and the second electrode 34, a reverse bias voltage may be applied to the first PN junction 42 and a forward bias voltage may be applied to the second PN junction 52. The first depletion region 44 may have a larger width than the second depletion region 54.

The width of the first depletion region 44 may increase in proportion to the level of a power supply voltage. The second depletion region 54 may have a small width independent of the level of a power supply voltage. When the first depletion region 44 and the second depletion region 54 meet each other, a current may flow between the first electrode 32 and the second electrode 34.

Most of light 20 propagating the rip waveguide 10 may penetrate the first and second depletion regions 44 and 54. The current flow through the first depletion region 44 and the second depletion region 54 may change the loss or refractive index of the light 20 according to Equation (1).

Thus, the electro-optic device 100 according to another exemplary embodiment of the present invention may change the loss or refractive index of the light 20 from the first to third impurity regions 40, 50 and 60 of a vertical NPN or PNP structure in the rip waveguide 10.

Referring to FIGS. 8 and 9B, an electro-optic device 100 according to another exemplary embodiment of the present invention may include first to third impurity regions 40, 50 and 60 of a vertical NN⁻N or PP⁻P structure stacked in a rip waveguide 10. The first and third impurity regions 40 and 60 may be doped with one of first conductivity type impurities and second conductivity type impurities at a high concentration. The second impurity region 50 may be doped with the first conductivity type impurities or the second conductivity type impurities at a low concentration.

A first junction 42 may be disposed at the boundary between the first impurity region 40 and the second impurity region 50. A second junction 52 may be disposed at the boundary between the second impurity region 50 and the third impurity region 60. The first junction 42 and the second junction 52 may include an NN⁻ junction or a PP⁻ junction.

When a voltage is applied to the first electrode 32 and the second electrode 34, a third depletion region 46 may be induced at the first junction 42 and a fourth depletion region 56 may be induced at the second junction 52. The third depletion region 46 and the fourth depletion region 56 may be induced in the second impurity region 50. The third depletion region 46 and the fourth depletion region 56 may have the same width. When the third depletion region 46 and the fourth depletion region 56 meet each other, a current may flow in the first to third impurity regions 40, 50 and 60. The current flow through the third depletion region 46 and the fourth depletion region 56 may change the loss or refractive index of light propagating in the rip waveguide 10.

Thus, the electro-optic device 100 according to another exemplary embodiment of the present invention may include first to third impurity regions 40, 50 and 60 with a vertical NPN, PNP, NN⁻N or PP⁻P structure in the rip waveguide 10.

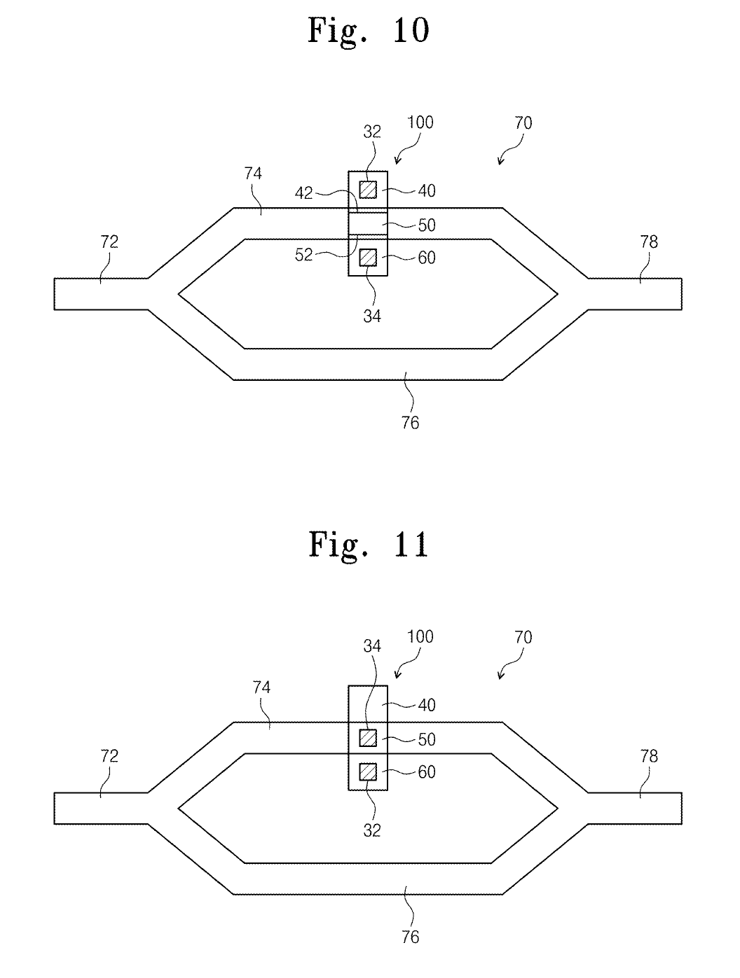

FIG. 10 is a plan view of a mach-zehnder optical modulator according to another exemplary embodiment of the present invention.

Referring to FIGS. 2A and 10, a mach-zehnder optical modulator 70 according to another exemplary embodiment of the present invention may include an electro-optic device 100 formed at one of a first branch waveguide 74 and a second branch waveguide 76 that are connected in parallel between an input waveguide 72 and an output waveguide 78.

The electro-optic device 100 may change the refractive index of one of the first and second branch waveguides 74 and 76. For example, the electro-optic device 100 may include a phase shifter that shifts the phase of light 20 propagating in the first branch waveguide 74. The refractive index may change the phase of the light 20 propagating in the first branch waveguide 74. The electro-optic device 100 may include first to third impurity regions 40, 50 and 60 of a NPN, PNP, NN⁻N or PP⁻P structure provided in the first branch waveguide 74. The first branch waveguide 74 and the second branch waveguide 76 may be a rip waveguide 10 that includes a mesa 14 and a slap 12 under the mesa 14. The rip waveguide 10 may be disposed on a substrate 16 and a lower clad 18.

The light 20 propagating through the input waveguide 72 may be divided into the first branch waveguide 74 and the second branch waveguide 76. Also, the light beam 20 propagating through the first branch waveguide 74 and the light beam 20 propagating through the second branch waveguide 76 may be combined in the output waveguide 78. The light beams 20 received from the first branch waveguide 74 and the second branch waveguide 76 is 0 or 2π, the light beams 20 may constructively/destructively interfere with each other in the output waveguide 78. When the phase difference between the light beams 20 propagating through the first branch waveguide 74 and the second branch waveguide 76 is π or −π, the light beams 20 may constructively interfere with each other in the output waveguide 78. When the phase difference between the light beams 20 propagating through the first branch waveguide 74 and the second branch waveguide 76 is π or −π, the light beams 20 may destructively interfere with each other in the output waveguide 78.

The electro-optic device 100 may include the first to third impurity regions 40, 50 and 60 with a lateral NPN or PNP structure across the first branch waveguide 74. The electro-optic device 100 change the phase of the light 20, which propagates through the first branch waveguide 74, to 0, 2π, π or −π according to the signal voltage applied to the first electrode 32 and the second electrode 34. Thus, the mach-zehnder optical modulator 70 may modulate the light 20 at high speed.

FIG. 11 is a plan view of a mach-zehnder optical modulator according to another exemplary embodiment of the present invention.

Referring to FIGS. 9A and 11, a mach-zehnder optical modulator 70 according to another exemplary embodiment of the present invention may include an electro-optic device 100 having first to third impurity region s40, 50 and 60 of a vertical NPN or PNP structure formed at one of a first branch waveguide 74 and a second branch waveguide 76 that are connected in parallel between an input waveguide 72 and an output waveguide 78. The electro-optic device 100 may vary the phase of light 20 that propagates through one of the first branch waveguide 74 and the second branch waveguide 76.

As described above, the electro-optic device according to the exemplary embodiments of the present invention may include first to third impurity regions having a lateral or vertical NPN or PNP structure in a rip waveguide. The NPN or PNP first to third impurity regions may have a lower capacitance than a typical PN diode. The electro-optic device according to the exemplary embodiments of the present invention can operate at high speed.

The above-disclosed subject matter is to be considered illustrative and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An electro-optic device comprising:
a slap disposed on a substrate;
a rip waveguide comprising a mesa extending in one direction on the slap and the slap disposed under the mesa;
a first impurity region disposed in the slap of one side of the mesa;
a third impurity region disposed in the slap of the other side of the mesa to oppose the first impurity region; and
a second impurity region disposed in the rip waveguide between the first impurity region and the third impurity region.

2. The electro-optic device of claim 1, wherein the first impurity region and the third impurity region are doped with first conductivity type impurities, and the second impurity region is doped with second conductivity type impurities having the opposite conductivity type to the first conductivity type impurities.

3. The electro-optic device of claim 2, wherein the first impurity region, the second impurity region and the third impurity region are arranged in a PNP or NPN structure.

4. The electro-optic device of claim 2, wherein the rip waveguide further comprises:
a first PN junction disposed between the first impurity region and the second impurity region; and
a second PN junction disposed between the second impurity region and the third impurity region.

5. The electro-optic device of claim 4, wherein the first PN junction induces a first depletion region from the interface between the first impurity region and the second impurity region, and the second PN junction induces a second depletion region from the interface between the second impurity region and the third impurity region.

6. The electro-optic device of claim 5, further comprising:
a first electrode disposed on the first impurity region; and
a second electrode disposed on the third impurity region.

7. The electro-optic device of claim 6, wherein a power supply voltage is applied between the first electrode and the second electrode to apply a reverse bias voltage to the first PN junction and apply a forward bias voltage to the second PN junction.

8. The electro-optic device of claim 7, wherein the width of the first depletion region increases to the second depletion region in proportion to the power supply voltage.

9. The electro-optic device of claim 8, further comprising:
a current flow occurs between the first electrode and the second electrode, wherein the current flow changes the refractive index of light that propagates along the rip waveguide

10. The electro-optic device of claim 8, wherein the current flow changes the loss of light that propagates along the rip waveguide.

11. The electro-optic device of claim 6, further comprising:
a first ohmic contact layer disposed between the first impurity region and the first electrode; and
a second ohmic contact layer disposed between the third impurity region and the second electrode.

12. The electro-optic device of claim 1, wherein the first impurity region and the third impurity region are doped with first conductivity type impurities of a first concentration, and the second impurity region is doped with the first conductivity type impurities of a second concentration lower than the first concentration.

13. The electro-optic device of claim 12, wherein the first impurity region, the second impurity region and the third impurity region are arranged in a PP⁻P or NN⁻N structure.

14. An electro-optic device comprising:
a slap disposed on a substrate;
a rip waveguide comprising a mesa extending in one direction on the slap and the slap disposed under the mesa;
a first impurity region disposed in the slap of the rip waveguide;
a third impurity region disposed on an upper mesa and spaced apart from the first impurity region; and
at least one second impurity region disposed in a lower mesa between the first impurity region and the third impurity region.

15. The electro-optic device of claim 14, wherein the first impurity region and the third impurity region are doped with first conductivity type impurities, and the second impurity region is doped with second conductivity type impurities having the opposite conductivity type to the first conductivity type impurities.

16. The electro-optic device of claim 15, wherein the first impurity region, the second impurity region and the third impurity region are arranged in a PNP or NPN structure.

17. The electro-optic device of claim 16, wherein the rip waveguide further comprises:
a first PN junction disposed between the first impurity region and the second impurity region; and
a second PN junction disposed between the second impurity region and the third impurity region.

18. The electro-optic device of claim 14, wherein the first impurity region and the third impurity region are doped with first conductivity type impurities of a first concentration, and the second impurity region is doped with the first conductivity type impurities of a second concentration lower than the first concentration.

19. The electro-optic device of claim 18, wherein the first impurity region, the second impurity region and the third impurity region are arranged in a PP⁻P or NN⁻N structure.

20. A mach-zehnder optical modulator comprising:
a substrate;
a clad disposed on the substrate;
a slap disposed on the clad;
a rip waveguide comprising a mesa extending in one direction on the slap, input/output waveguides inputting/outputting light along the mesa and the slap disposed under the mesa, and first and second branch waveguides connected in parallel between the input/output waveguides; and
an electro-optic device comprising a first impurity region disposed at one side of the mesa in at least one of the first and second branch waveguides, a third impurity region disposed at the other side of the mesa to oppose the first impurity region, and at least one second impurity region disposed in the rip waveguide between the first impurity region and the third impurity region.
